(19) United States
(12) Patent Application Publication
(10) Pub. No.: US 2010/0122753 A1
(43) Pub. Date: May 20, 2010

(54) CONCRETE SLURRY TRANSPORTING PIPE FOR CONCRETE PUMP-CAR

(75) Inventor: JIN-HYUN JEONG, Gyeonggi-do (KR)

Correspondence Address: David A. Einhorn, Esq.;Baker & Hostetler LLP, 45 Rockefeller Plaza, New York, NY, 10111, US

(73) Assignee: TMC Corp. and Jin-Hyun JEONG

(21) Appl. No.: 12/622,094

(22) Filed: Nov. 19, 2009

(30) Foreign Application Priority Data
Nov. 19, 2008 (KR) 10-2008-115225

(51) Int. Cl. F16L 9/22

(52) U.S. Cl. 148/520; 148/519; 138/178

(57) ABSTRACT

Disclosed is a concrete slurry transporting pipe for concrete pump-cars, which has improved wear resistance to friction with sands or gravels and impact resistance during transportation of concrete slurry. The pipe is a steel pipe made of carbon steel, and includes a heat-treated section having a hardness of Hv 450 or more and formed by induction-heating a portion of an inner or outer surface of the pipe, followed by cooling the heated portion of the inner or outer surface to harden the heated portion, and a non-heat treated section adjoining the heat-treated section. The heat-treated section and the non-heat treated section are alternately formed in a spiral band arrangement along a length of the pipe, and the heat-treated section has a greater width than the non-heat treated section.

### BACKGROUND OF THE INVENTION

1. Field of the Invention

The present invention relates to concrete slurry transporting pipes for concrete pump-cars used and, more particularly, to concrete slurry transporting pipes for concrete pump-cars, which demonstrate improved wear resistance and impact resistance to external impact on an inner periphery of the pipe undergoing severe wear when concrete slurry is transported through the pipe.

2. Description of the Related Art

In general, a concrete pump-car (pump truck) is a tool for forcibly transporting concrete slurry (or cement mortar slurry, hereinafter referred to as the “concrete slurry”), received in the form of ready-mixed concrete, i.e., remicon, from a remicon vehicle through a hopper at a construction site, to a higher position of a tall building or the like under construction by pumping the concrete slurry while pressing it in a hydraulic cylinder.

Such a concrete pump car includes a cylinder unit compressing concrete slurry, and a transporting pipe providing a path for transporting the compressed concrete slurry to a casting position.

Since concrete slurry is prepared by mixing high hardness materials such as sands and gravels, surfaces of the components contacting the concrete slurry inevitably undergo some levels of continuous wear, pressure from the concrete slurry transported at a high pressure of about 140 bars, and unpredicted impact from outside in some cases during transportation of the concrete slurry.

As such, the transporting pipe is susceptible to continuous propagation of wear while undergoing a considerable level of pressure from the concrete slurry which is transported at a high pressure therein. In this condition, the transporting pipe is liable to be abruptly fractured by external impact, causing severe accidents. Accordingly, it is important to improve wear resistance and impact resistance of the transporting pipe so as to prevent fracture of the transporting pipe.

A conventional concrete slurry transporting pipe is made of low-carbon steel that has high ductility and is not subjected to heat treatment.

However, the non-heat treated transporting pipe made of low-carbon steel and having high ductility is likely to be damaged by various impacts when a concrete slurry mixture prepared by mixing water with a basic cement, high hardness sands, gravels, crushed stones, and the like collides with an inner surface of the pipe while passing at high pressure and speed therethrough.

Generally, the transporting pipe undergoes a combination of damages that include interior scratching or abrasive damage caused by friction between the sands or gravels and the inner surface of the pipe, impact damage caused by collision of the sands or gravels against the pipe, and corrosion caused by water and the basic cement in the slurry.

Since the low-carbon steel transporting pipe is not heat-treated and has a very low hardness of Hv 150˜250, the pipe undergoes abrasive wear by high hardness sands and the like contained in the concrete slurry. However, since there is no separate means for improving wear resistance to such abrasive hardness, the conventional transporting pipe is liable to be worn to the extent of a wear limit after a predetermined period of use.

Further, impact wear occurs on the inner surface of the pipe by gravel and the like in the concrete slurry transported at high pressure through the pipe and reduces lifespan of the pipe together with the abrasive wear, thereby causing the pipe or components thereof to be continuously replaced during the use thereof.

To solve such problems, a double-pipe for a concrete slurry transporting pipe has been developed which includes an inner pipe subjected to heat treatment to have wear resistance and an outer pipe that is not subjected to heat treatment to have impact resistance.

The double-pipe is fabricated by heat-treatment joining or mechanical press-fitting to force the inner and outer pipes to closely contact each other. In these methods, however, since the inner pipe is separately fabricated and assembled to the outer pipe after heat treatment, it is difficult to control dimensional deformation of the inner pipe by heat treatment and any severe dimensional error makes it difficult to assemble the inner and outer pipes.

In particular, when the inner pipe is long and deformed during heat treatment, it is difficult to set press-fitting tolerances of the inner and outer pipes when press-fitting the inner pipe into the outer pipe. Namely, since it is important to prevent separation of the inner and outer pipes assembled to each other (to maintain a separation force of a critical value or more after press-fitting), the press-fitting tolerances cannot be increased above a suitable level. As a result, a great press-fitting load is often required to press-fit the inner pipe into the outer pipe, thereby causing an increase in size of a press-fitting device and a decrease in economic feasibility.

On the other hand, the method of joining the inner pipe to the outer pipe through heat treatment requires an expensive heat treatment device and cannot achieve uniform joining of all planes by the heat treatment for long pipes.

Moreover, such a double-pipe is heavier than a single-pipe, thereby providing an excessive load to a boom that supports the pipe at a construction site.

### SUMMARY OF THE INVENTION

The present invention is conceived to solve the problems of the related art as described above, and an aspect of the invention is to provide a concrete slurry transporting pipe for a concrete pump-car which has a comparatively low weight and demonstrates improved impact resistant and wear resistance to corrosion and friction with gravels and sands during transportation of concrete slurry therethrough.

More specifically, the invention provides a concrete slurry transporting pipe for a concrete pump-car, which includes heat-treated sections providing wear resistance to the pipe when concrete slurry passes at high pressure through the pipe and non-heat treated sections providing impact resistance to absorb impact from the interior and the exterior of the pipe, thereby demonstrating high wear resistance to abrasive wear and improved impact resistance so as to ensure sufficient life span of the pipe. With this configuration, the concrete slurry transporting pipe can be fabricated without heat-treatment after assembling inner and outer pipes or a separate process for press-fitting the inner pipe into the outer pipe, thereby enhancing workability while significantly reducing the likelihood of defect generation during fabrication.

In accordance with one aspect, a concrete slurry transporting pipe for a concrete pump-car is a steel pipe (for example, circular cross-section pipe) made of carbon steel, and includes: a heat-treated section having a hardness of Hv 450 or more and formed by induction-heating a portion of an inner or outer surface of the pipe, followed by cooling the heated portion of the inner or outer surface to harden the heated portion; and a non-heat treated section adjoining the heat-treated section. Here, the heat-treated section and the non-heat treated section are alternately formed in a spiral band arrangement along a length of the pipe, and the heat-treated section has a greater width than the non-heat treated section.

### BRIEF DESCRIPTION OF THE DRAWINGS

The above and other aspects, features and advantages of the invention will become apparent from the following detailed description in conjunction with the accompanying drawings, in which:

FIG. 1 is a view of a heat treatment pattern formed on a concrete slurry transporting pipe by regional division heat treatment in accordance with one embodiment of the present invention;

FIG. 2 is a view of a heat treatment pattern formed on a concrete slurry transporting pipe by regional division heat treatment in accordance with another embodiment of the present invention;

FIG. 3 is a view of a heat treatment pattern formed on a concrete slurry transporting pipe by regional division heat treatment in accordance with a further embodiment of the present invention;

FIG. 4 is a view of an induction heat-treatment arrangement in accordance with one embodiment of the present invention;

FIGS. 5 and 6 are views of induction heat-treatment arrangements in accordance with other embodiments of the present invention;

FIG. 7 is a view of an induction heat-treatment arrangement in accordance with still another embodiment of the present invention, in which induction coils are arranged in parallel;

FIG. 8 is a flowchart of a method of fabricating a concrete slurry transporting pipe in accordance with one embodiment of the present invention;

FIG. 9 is a flowchart of a method of fabricating a concrete slurry transporting pipe in accordance with another embodiment of the present invention;

FIG. 10 is a graph depicting a surface hardness profile of a concrete slurry transporting pipe in accordance with one embodiment of the present invention;

FIG. 11 is a graph depicting a depthwise hardness profile of a heat-treated section of the concrete slurry transporting pipe in accordance with the embodiment of the present invention;

FIG. 12 is a schematic view of a sand wear tester; and

FIG. 13 shows a wear aspect of a concrete slurry transporting pipe in accordance with one embodiment of the present invention after sand wear testing.

### DETAILED DESCRIPTION OF THE EMBODIMENTS

Embodiments of the invention will now be described in detail with reference to the accompanying drawings.

The present invention may be applied to any kind of concrete slurry transporting pipe that can be classified into a delivery elbow having a curved shape and a delivery pipe having a linear shape according to the shape of the pipe, or that can be classified into a swing pipe, a reducing pipe according to operation thereof. A concrete slurry transporting pipe according to one embodiment of the invention is fabricated using a medium-carbon steel pipe that has a circular cross-section.

According to the invention, the carbon content of the steel pipe for the concrete slurry transporting pipe may vary depending on a fabrication manner. When the steel pipe is fabricated by machining a steel sheet to have a circular shape and welding the circular sheet, the carbon content is set to 0.45 wt % or less for welding, and when the steel pipe is fabricated by drawing or extruding a steel bar, the carbon content is set to 0.8 wt % or less in consideration of strength and ductility of the steel bar during drawing or extrusion. Further, when the steel pipe is formed by centrifugal casting or continuous casting a molten metal, the carbon content increases up to 2.5 wt %, that is, the carbon content of cast steel. Thus, according to the invention, the steel pipe for the concrete slurry transporting pipe contains up to 2.5 wt % carbon.

Here, in order to allow a concrete slurry transporting pipe according to one embodiment to have a hardness of Hv 450 or more through induction heat treatment by an induction current, the steel pipe may contain 0.30 wt % or more carbon. If the carbon content of the steel pipe for the transporting pipe is less than 0.30 wt %, the transporting pipe is not sufficiently hardened by local heat treatment, so that sufficient wear resistance is not ensured.

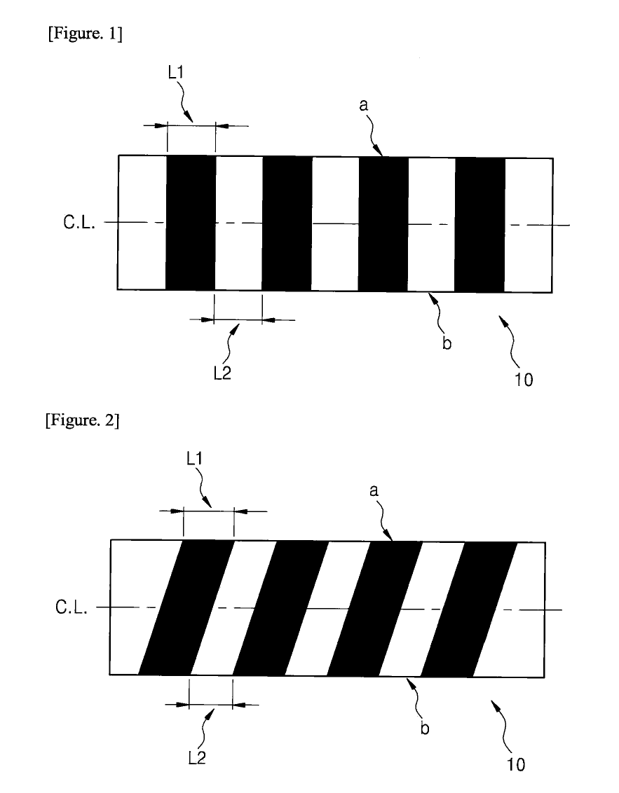

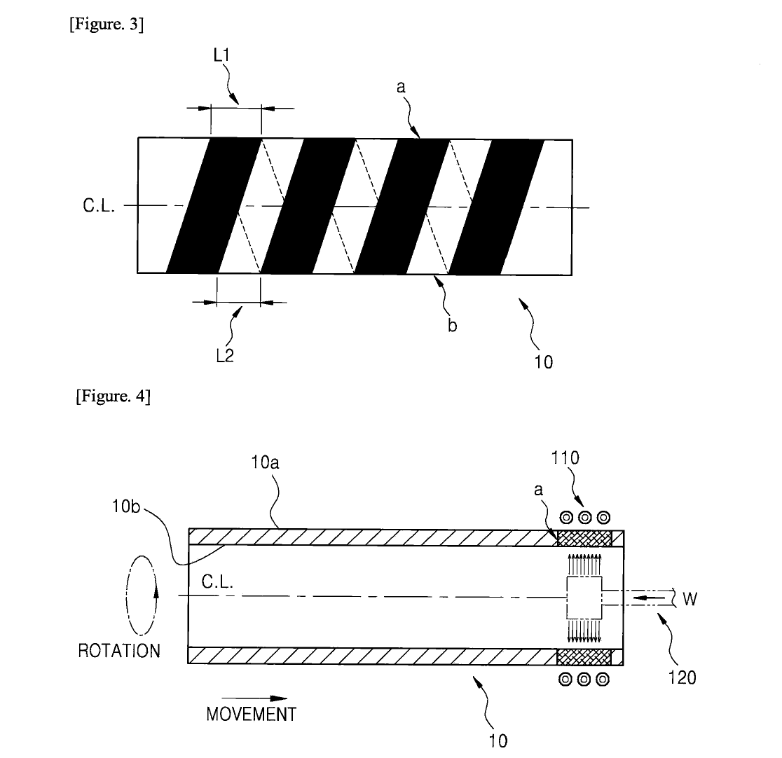

FIG. 1 is a view of a heat treatment pattern formed on a concrete slurry transporting pipe by regional division heat treatment in accordance with one embodiment of the invention, FIG. 2 is a view of a heat treatment pattern formed on a concrete slurry transporting pipe by regional division heat treatment in accordance with another embodiment of the invention, and FIG. 3 is a view of a heat treatment pattern formed on a concrete slurry transporting pipe by regional division heat treatment in accordance with a further embodiment of the present invention.

Referring to FIGS. 1 to 3, a concrete slurry transporting pipe 10 according to one embodiment is subjected to regional division heat treatment, and includes heat-treated sections “a”, which are subjected to heat treatment to have high hardness, and non-heat treated sections “b”, which are not subjected to heat treatment. Here, the heat-treated sections “a” and the non-heat treated sections “b” are alternately arranged so that the heat-treated sections “a” demonstrate wear resistance characteristics and the non-heat treated sections “b” absorb impact and prevent fracture of the pipe.

In the concrete slurry transporting pipe 10 of the embodiment shown in FIG. 1, both the heat-treated section “a” and the non-heat treated section “b” are formed perpendicular to a center line C.L. of the pipe 10 and have a circular band shape independent of each other. To fabricate the concrete slurry transporting pipe 10 of this embodiment as shown in FIG. 1, an induction heat-treatment arrangement according to one embodiment of the invention is installed as shown in FIG. 4. In this embodiment, the induction heat-treatment arrangement includes an induction coil 110 disposed around an outer surface 10a of the pipe 10 to be perpendicular to the center line C.L. of the pipe 10, and a water-cooling unit 120, for example, a water-jet cooler having jet-nozzles, disposed at a location inside an inner surface 10b of the pipe 10 corresponding to the induction coil 110. In this induction heat-treatment arrangement, heat treatment of the transporting pipe 10 is performed by heating the pipe 10 with an induction current flowing through the induction coil 110, followed by jetting cooling water “w” to the inner surface 10b of the pipe 10 through the water-cooling unit 120 for quenching the heated piped. Here, if such operations of induction heating and water cooling are performed while rotating the pipe 10 using a rotation unit (not shown), the heat treatment can be achieved more uniformly. Then, when a single heat-treated section “a” on the pipe 10 is obtained through a series of heat treatment operations as described above, the pipe 10 is shifted a predetermined distance to form a subsequent heat-treated section “a”. As a result, the non-heat treated section “b” has the same distance as the predetermined distance by which the pipe 10 is shifted.

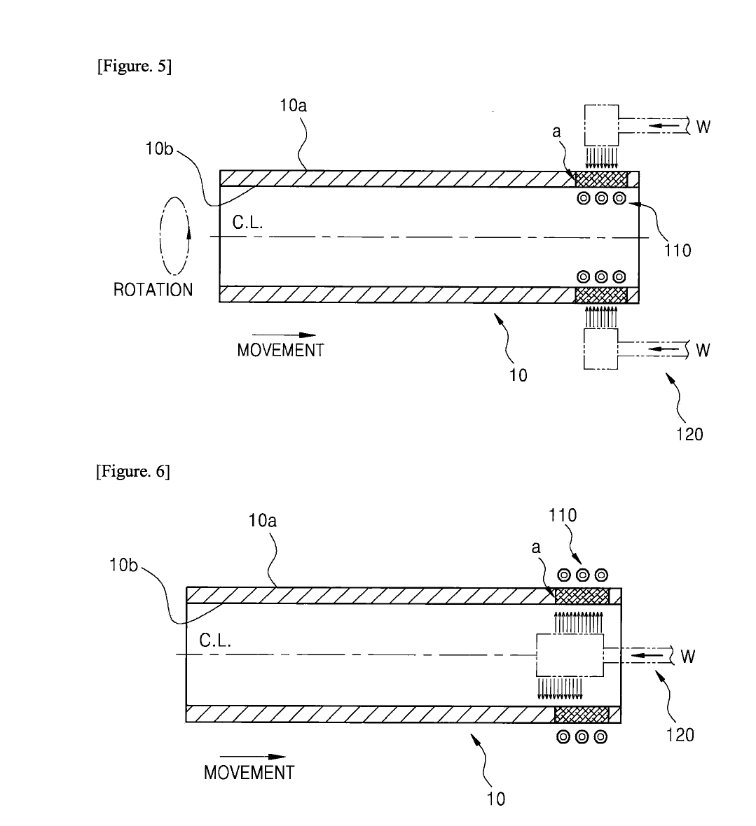

In another embodiment as shown in FIG. 5, the induction coil 10b may be disposed inside the inner surface 10b of the pipe 10 and the water-cooling unit 120 may be disposed at a location corresponding to the induction coil 10b to surround the outer surface 10a of the pipe 10, contrary to the embodiment shown in FIG. 4.

On the other hand, it is advantageous in view of uniform wear resistance to form the heat-treated sections “a” to have a greater width L1, for example, 4 mm, than a width L2, for example, 2 mm, of the non-heat treated sections “b”.

Referring to FIG. 2, a concrete slurry transporting pipe 10 according to another embodiment includes heat-treated sections “a” and non-heat treated sections “b”, which are alternately formed at an angle to the center line C.L. of the pipe 10 and have an independent circular band shape. To fabricate the pipe 10 of this embodiment, the induction coil 110 of the induction heat-treatment arrangement is disposed around the outer surface 10a of the pipe 10 at an angle to the center line C.L. of the pipe 10. The case where the induction coil 110 is disposed inside the inner surface 10b of the pipe 10 is not shown herein. Heat treatment of the pipe 10 of this embodiment may be performed through the same processes as those described above with reference to FIGS. 1, 4 and 5.

Referring to FIG. 3, a concrete slurry transporting pipe 10 according to a further embodiment includes heat-treated sections “a” and non-heat treated sections “b”, which are alternately formed in a spiral band arrangement in a longitudinal direction of the pipe 10. To fabricate the pipe 10 of this embodiment, with the induction coil 110 of the induction heat-treatment arrangement disposed around the outer surface 10a of the pipe 10 (see FIG. 4) or inside the inner surface 10b of the pipe 10 (see FIG. 5) to be perpendicular to the center line C.L. of the pipe 10, as shown in FIGS. 4 and 5, the pipe 10 is moved in the longitudinal direction while being rotated at low speed during heat treatment. Here, the heat treatment is performed by heating the pipe 10 with an induction current flowing through the induction coil 110, followed by jetting cooling water “w” to the inner surface 10b of the pipe 10 (see FIG. 4), the outer surface of the pipe 10 (see FIG. 5) or to both inner and outer surfaces 10a and 10b of the pipe 10 at the same time (not shown) through the water-cooling unit 120 for quenching the heated section, thereby forming the heat-treated sections “a” in a continuous spiral band arrangement on the pipe 10.

Here, when alternately forming the heated sections (that is, heat-treated sections) and the non-heated sections (that is, non-heat treated sections) by induction heating, the widths of the heated section and the non-heated section may be determined by adjusting the moving speed and the rotating speed of the pipe according to various variables such as heating capacity (that is, current density per unit area, W/cm²) depending on performance of the induction coil and a power source, thickness of the heated section, and the like. For example, for an induction current generator of high heating capacity, the pipe may be set to move at high moving and rotating speeds to form the heated sections having the same width. On the other contrary, for an induction current generator of low heating capacity, the pipe may be set to move at low moving and rotating speeds to form the heated sections having the same width.

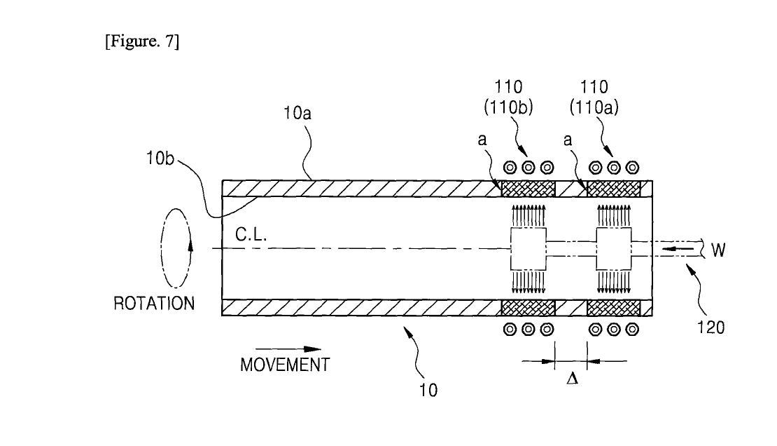

FIG. 7 shows an induction heat-treatment arrangement in accordance with still another embodiment of the invention, which is used for regional division heat treatment of a concrete slurry transporting pipe in accordance with one embodiment of the invention. In this embodiment, the induction heat-treatment arrangement includes at least two induction coils 110a, 110b connected in parallel to a power source (not shown) and separated a predetermined distance “Δ” from each other around the outer surface 10a of the pipe 10 and a water-cooling unit 120 having jet-nozzles disposed at locations corresponding to the induction coils 110a, 110b inside the inner surface 10b of the pipe 10, so that a pair of heat-treated sections “a” and a non-heat treated section therebetween can be formed at the same time in the longitudinal direction of the pipe 10. In FIG. 7, the induction heat-treatment arrangement is shown as including two induction coils 110a, 110b, but it may include three or more induction coils. Further, it should be noted that the induction coils 110a, 110b may be disposed inside the inner surface 10b of the pipe and the jet-nozzles of the water-cooling unit 120 may be disposed at one or more locations not only inside the inner surface 10b of the pipe but also around the outer surface 10a thereof.

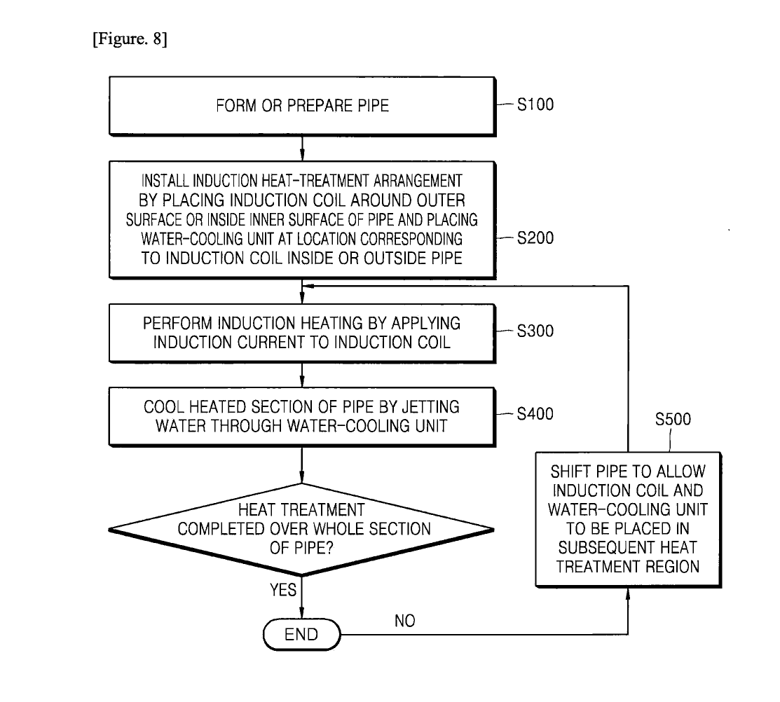

FIG. 8 is a flowchart of a method of fabricating a concrete slurry transporting pipe, which includes heat-treated sections having an independent band shape as shown in FIGS. 1 and 2, in accordance with one embodiment of the invention.

In this embodiment, the method includes: preparing a steel pipe having a carbon content of 0.3˜2.5 wt % in S100; disposing an induction heat-treatment arrangement for regional division heat treatment of the pipe by placing an induction coil at a predetermined location around an outer surface of the pipe or inside an inner surface of the pipe for induction heating of a predetermined section on the outer or inner surface of the pipe, and a water-cooling unit at a predetermined location corresponding to the induction coil inside the inner surface or around the outer surface of the pipe for cooling and hardening the heated section of the pipe, in S200; allowing an induction current to flow through the induction coil to perform induction heating of the pipe in S300; and cooling the heated section of the pipe using the water-cooling unit in S400.

Then, until heat treatment of an overall section of the pipe is completed, the pipe is shifted to allow the induction coil and the water-cooling unit to be located at a subsequent heat treatment section in S500, followed by induction heating in S300 and water cooling in S400.

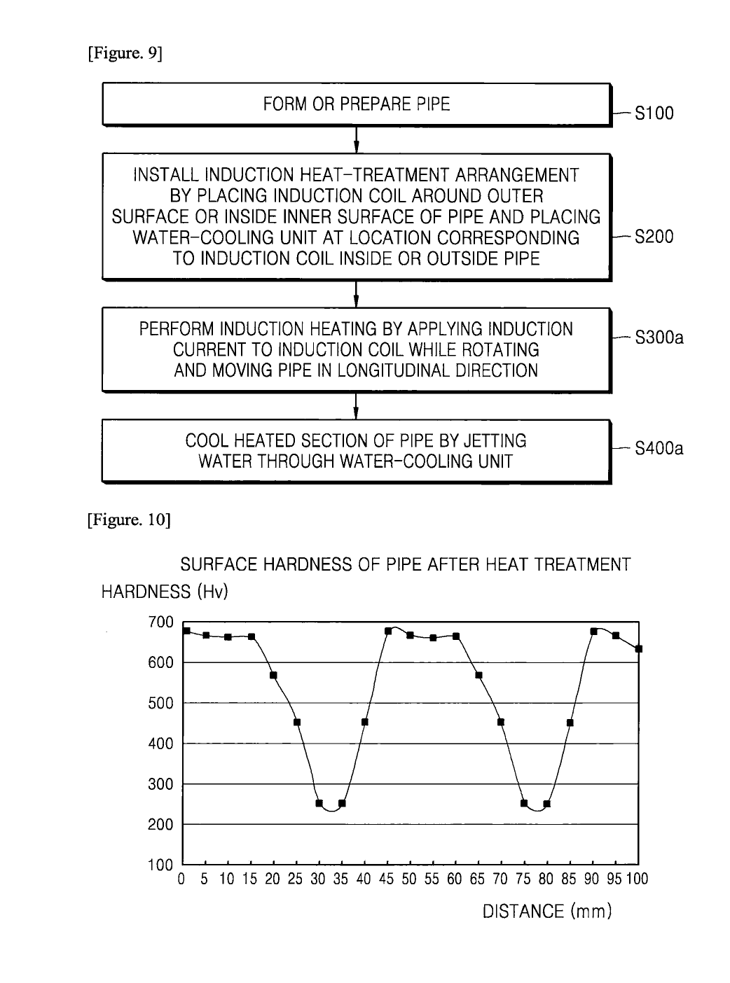

FIG. 9 is a flowchart of a method of fabricating a concrete slurry transporting pipe, which includes heat-treated sections having a spiral band shape as shown in FIG. 3, in accordance with another embodiment of the invention.

Referring to FIG. 9, in this embodiment, the method includes: preparing a steel pipe in S100; disposing an induction heat-treatment arrangement for regional division heat treatment in S200; allowing an induction current to flow through an induction coil of the induction heat-treatment arrangement while rotating the pipe and moving the pipe in the longitudinal direction of the pipe at the same time, in S300a; and cooling the heated section of the pipe using a water-cooling unit disposed at a location corresponding to the induction coil inside the inner surface or around the outer surface of the pipe, in S400a.

FIG. 10 is a graph depicting a surface hardness profile of a concrete slurry transporting pipe subjected to regional division heat treatment in accordance with one embodiment of the invention.

In FIG. 10, the heat-treated sections of the pipe have a high hardness of Hv 600 or more, thereby demonstrating improved wear resistance to concrete slurry moving inside the pipe. The non-heat treated sections of the pipe have a hardness of Hv 250 or more, which is slightly greater than that of the matrix (that is, material of the pipe), so that the non-heat treated sections of the pipe endure a high pressure of 140 bars in the pipe and absorb external impact, thereby preventing fracture of the pipe by the impact.

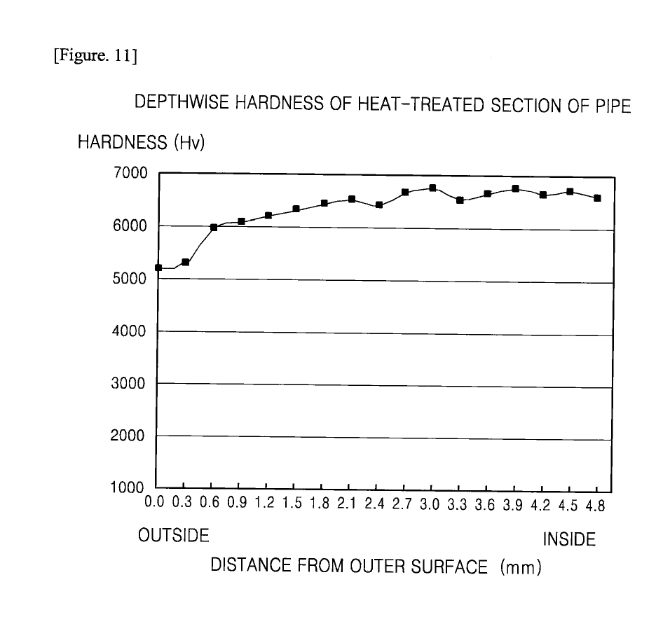

FIG. 11 is a graph depicting a depthwise hardness profile of a heat-treated section of the concrete slurry transporting pipe according to the embodiment of the invention.

As can be seen from FIG. 11, hardening proceeds over the whole thickness of the pipe from the inner surface to the outer surface in the heat-treated section of the pipe. The hardening was obtained by performing induction-heating of a predetermined section of the pipe using the induction coil installed in a predetermined region around the outer surface of the pipe, followed by water-cooling (water-jet cooling) the heated section of the pipe at an interior location of the pipe corresponding to the induction coil for quenching the heated section of the pipe, as shown in FIGS. 4 and 6.

Here, a sufficiently hardened depth (distance from the outer surface to the inner surface of the pipe) can be obtained by performing sufficient induction heating from the outer surface of the pipe, where the induction coil is disposed, to the inner surface of the pipe. For this purpose, it is desirable to select a suitable frequency of induction heating power depending on the thickness of the target pipe. Generally, application of a high frequency current to an induction coil leads to an outer skin effect wherein the current (heating current) is concentrated on a surface of a conductor (pipe), and a higher frequency of the induction current tends to increase the outer skin effect (that is, decreases an infiltration depth). Here, a relationship between the infiltration depth and the frequency can be expressed by the following Equation 1:

δ=k(ρ/(μ·f))^{0.5} (1)

where δ is an infiltration depth (m), ρ is an inherent resistance of the conductor (pipe), μ is a relative dielectric constant, and f is a frequency of the induction current.

For example, for a pipe having a thickness of 3 mm or less, an induction current in a high frequency range of 50 kHz˜500 kHz may be used for induction heating of the pipe to allow the pipe to be sufficiently heated from the outer surface to a shallow depth of the pipe. For a pipe having a thickness of 3˜5 mm, an induction current in a middle frequency range of 10 kHz˜50 kHz may be used, and for a pipe having a thickness of 5 mm or more, an induction current in a low frequency range of 100 Hz˜10 kHz may be used, for induction heating of the pipe to allow the pipe to be sufficiently heated from the outer surface to a deep depth of the pipe.

In this embodiment, since water-jet cooling is performed inside the pipe, the inner surface of the pipe has a higher hardness than the outer surface of the pipe due to quenching effects, whereas the outer surface of the pipe can be slightly decreased in hardness. Even in this case, however, both the inner and outer surfaces of the pipe may have a hardness of Hv 450 or more to allow the hardness of the pipe to be kept at a predetermined level or more over the whole cross-section of the pipe, thereby improving wear resistance.

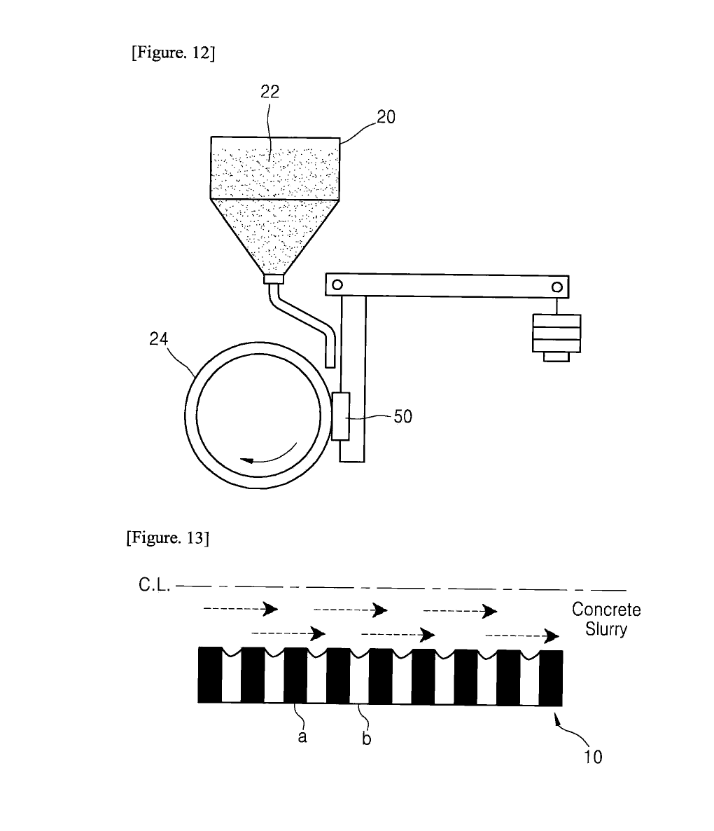

Several specimens including a plurality of heat-treated sections and non-heat treated section were taken from a concrete slurry transporting pipe subjected to regional division heat treatment according to one embodiment, and wear testing of the specimens was performed using a sand wear tester as shown in FIG. 12.

Specifically, referring to FIG. 12, the wear testing was performed by compressing a specimen 50 at a force of 15 kgf while spraying sand to the specimen 50 at a constant speed through a hopper 20 and rotating a wheel 24 at 200 rpm until the wheel 24 was rotated 20,000 times.

Then, a wear amount of the specimen 50 was measured by measuring a difference in weight of the specimen before and after the wear testing using an electronic balance having a precision of 1/1000 g, and dividing the weight difference by a theoretical density of a raw material of the specimen. Table 1 summarizes the results of the wear testing.

Table 1 shows surface hardness and wear amount of a raw material pipe, a completely heat treated pipe, and an inventive pipe subjected to regional division heat treatment after the sand wear testing.

Three specimens were prepared from each of the pipes and subjected to the sand wear testing under the same conditions. All of the pipes were made of S45C steel that contains 0.45 wt % carbon.

The specimens tested as Comparative Example 1 were prepared from the raw material pipe which was not subjected to heat treatment, and the specimens tested as Comparative Example 2 were prepared from the completely heat treated pipe, which was prepared by performing heat treatment over the whole section of the raw material pipe. The specimens tested as Example included 4 mm long heat-treated sections (hardened section) and 2 mm long non-heat treated sections (non-hardened section) alternately formed in a spiral band arrangement. In Table 1, an average value of the three specimens is provided as the wear amount.

TABLE 1

| | | | Surface | Wear |
|---|---|---|---|---|
| Specimen | | Material | Hardness | amount (g) |
| Regional division | Hardened section | SC45C | Hv 650 | 0.451 |
| HT (Example) | (4 mm) | | | |
| | Non-hardened | SC45C | Hv 250 | |
| | section (2 mm) | | | |

| | | | |
|---|---|---|---|
| Raw material pipe | SC45C | Hv 250 | 1.890 |
| (Comparative Example 1) | | | |
| Complete heat treatment over whole | SC45C | Hv 660 | 0.423 |
| section (Comparative Example 2) | | | |

In Table 1, the raw material pipe (Comparative Example 1) not subjected to induction heat treatment has a wear amount of 1.890 g, and the completely hardened pipe (Comparative Example 2) subjected to the complete heat treatment over the whole section has a wear amount of 0.423 g, which demonstrates that the wear resistance of Comparative Example 2 is about 4.5 times better than that of Comparative Example 1.

For the concrete slurry transporting pipe of Example subjected to regional division heat treatment and having the heat-treated sections (4 mm) and the non-heat treated sections (2 mm) alternately formed along the pipe, the wear amount (0.451 g) is substantially similar to that of Comparative Example 2 despite the non-heat treated sections, thereby ensuring good endurance properties in terms of wear resistance.

Furthermore, since the concrete slurry transporting pipe of Example includes the non-heat treated sections serving to buffer an impact force as well as the heat-treated sections providing good wear resistance, the pipe is unlikely to be fractured by the impact force and can be used over the full lifespan thereof, thereby ensuring good endurance properties in term of impact resistance.

On the other hand, the pipe of Comparative Example 2 subjected to the complete heat treatment over the whole section is highly liable to be fractured by internal or external impact since there is no separate means for buffering impact when the impact is applied to the pipe undergoing thickness reduction to some degrees by wear during the use of the pipe.

FIG. 13 shows a wear aspect on the inner surface of the concrete slurry transporting pipe cut after the wear testing. Referring to FIG. 13, it can be seen that, unlike the heat-treated sections, the non-heat treated sections “b” of the pipe undergo some degrees of wear by friction with concrete slurry flowing through the pipe.

In the non-heat treated sections “b” of the pipe where some degrees of wear proceed for a predetermined period, vortex of the concrete slurry occurs at a concave portion formed by the wear to thereby lower friction on the non-heat treated sections “b.” Consequently, a propagation speed of wear is significantly lowered so that the wear does not proceed anymore on the non-heat treated sections. Such a wear aspect can easily explain a minor difference in wear amount between Example and Comparative Example 2, which was subjected to the complete heat treatment over the whole section of the pipe.

Furthermore, such a wear aspect results from a wear behavior by surface texture of the pipe and is affected by speed, pressure and viscosity of the fluid flowing in the pipe.

In the concrete slurry transporting pipe subjected to repetitious regional heat treatment according to the embodiment, the wear aspect as shown in FIG. 13 allows the hardened sections, that is, heat-treated sections “a”, and the non-heat treated sections “b” to act as a composite material so that the heat-treated sections are responsible for wear resistance and the non-heat treated sections are responsible for impact resistance, thereby reducing the wear amount of the pipe while preventing fracture of the pipe by impact during the use of the pipe.

As such, according to the embodiment, the concrete slurry transporting pipe for a concrete pump-car is made using a single pipe to thereby prevent an increase in weight of the pipe and demonstrates improved impact resistance and high wear resistance not only to corrosion but also to friction with gravels and sands during transportation of concrete slurry therethrough.

Although some embodiments have been provided to illustrate the invention in conjunction with the drawings, it will be apparent to those skilled in the art that the embodiments are given by way of illustration only, and that various modifications and variations can be made without departing from the spirit and scope of the invention. The scope of the invention should be limited only by the accompanying claims.

1. A concrete slurry transporting pipe for a concrete pump-car, the pipe being a steel pipe made of carbon steel, and comprising:
a heat treated section having a hardness of Hv 450 or more and a non-heat treated section adjoining the heat-treated section,
wherein the heat-treated section and the non-heat treated section are spirally formed along a length of pipe in an alternate sequence to form alternate bands of heat treated and non-heat treated pipe with the width of each band of heat treated pipe being greater than the width of each band of non-heat treated pipe and with the heat treated section being formed by the process consisting of induction-heating a portion of an inner or outer surface of the pipe, followed by cooling the heated portion of the inner or outer surface to harden the heated portion.

2. The concrete slurry transporting pipe according to claim 1, wherein the carbon steel comprises 0.30˜2.5 wt % carbon.

3. A concrete slurry transporting pipe for a concrete pump-car, the pipe being a steel pipe made of carbon steel, and comprising:
a heat-treated section having a hardness of Hv 450 or more and formed by induction-heating a portion of an inner or outer surface of the pipe, followed by cooling the heated portion of the inner or outer surface to harden the heated portion; and
a non-heat treated section adjoining the heat-treated section,
wherein the heat-treated section and the non-heat treated section are spirally formed along a length of pipe in an alternate sequence to form alternate bands of heat treated and non-heat treated pipe with the width of each band of heat treated pipe being greater than the width of each band of non-heat treated pipe.

4. The concrete slurry transporting pipe according to claim 3, wherein the carbon steel comprises 0.30˜2.5 wt % carbon.
